(19) United States
(12) Patent Application Publication
(10) Pub. No.: US 2026/0311609 A1
(43) Pub. Date: Oct. 8, 2026

(54) Smarty Pants

(71) Applicant: Brett Edmond, Annapolis, MD (US)

(72) Inventor: Brett Edmond, Annapolis, MD (US)

(21) Appl. No.: 19/172,577

(22) Filed: Apr. 7, 2025

(51) Int. Cl. G09B 3/00; A41B 9/00; A41B 11/00; A41D 11/00; G09B 1/06

(52) U.S. Cl. CPC G09B 3/00; A41D 11/00; G09B 1/06; A41B 9/00; A41B 11/001

(57) ABSTRACT

A learning system and clothing article designed to enable young children to learn and distinguish left and right sides of their body for getting dressed independently. The clothing article(s) use distinct colors and or shapes and symbols to indicate left and right so that young children can put on their underwear, clothes and shoes without assistance from an adult.

### CROSS REFERENCE TO RELATED APPLICATIONS

None

### STATEMENT REGARDING FEDERALLY SPONSORED RESEARCH OR DEVELOPMENT

None.

### TECHNICAL FIELD

This disclosure relates to systems and clothing article for training young children to dress themselves and learn information while getting dressed. More specifically a system for color, shape and design matching using undergarments.

### BACKGROUND

Toddlers and young children have always desired to become more and more independent despite their youth. “I can do it myself”, and “let me do it” seems to be an anthem and some of the first phrases learned by little ones. Their need for autonomy and desire to feel older by taking on tasks without assistance from their parents presents a constant challenge during the early training and development years. Parents have consistently struggled to balance the need to get daily tasks done, like getting the children dressed properly in a timely fashion, with the child's need to get dressed without interference or assistance from the parents.

### SUMMARY

The present system and apparatus provide tools that the parent can give to the child to use the visual cues provided in the articles of clothing to determine which leg or foot goes where without the parent having to intervene. The system also optionally uses child friendly adhesive stickers that can be placed on the back of each hand of the child as an additional visual reference point. The stickers contain a matching image of the design shown on the article of clothing. If the child is in need of a visual reference point, the parent can place a left side design sticker on the back of the child's left hand, and a right-side design sticker on the back of the child's right hand.

In a preferred embodiment, the system and apparatus include a pair of underwear and a pair of socks along with the stickers, such that the parent can place the stickers on the back of the child's hands, and the child can then use the stickers to match the left and right sides of the underwear, and match the left and right socks with their left or right foot.

In one exemplary embodiment, a color-coded pair of underwear or socks has a certain color to correspond with the left side of the underwear or left sock and a separate color to indicate the right side or right sock.

In another exemplary embodiment, the colors and/or shapes displayed on the article of clothing can be used to teach or reinforce recognition of the colors and shapes or objects.

In another exemplary embodiment, the food item displayed on the article of clothing can be used to teach or reinforce recognition of the food item along with an associated color of the food item.

In another exemplary embodiment, the numbers displayed on the article of clothing can be used to teach or reinforce recognition of the numbers and or colors of the numbers.

In another exemplary embodiment, the letters of the alphabet displayed on the article of clothing can be used to teach or reinforce recognition of the letters and/or the colors and the letters.

In another exemplary embodiment, the animals displayed on the article of clothing can be used to teach or reinforce recognition of the animals and/or the color associated with the animal.

In another exemplary embodiment, the vehicle displayed on the article of clothing can be used to teach or reinforce recognition of the vehicle or type of vehicle along with recognition of the vehicle color.

In another exemplary embodiment, the language displayed on the article of clothing can be used to teach or reinforce recognition of the language along with association of the language with a displayed color.

In another exemplary embodiment, the country or continent displayed on the article of clothing can be used to teach or reinforce recognition of geography.

In yet another exemplary embodiment, scenes of nature displayed on the article of clothing can be used to teach or reinforce recognition of nature.

Certain advantages of the systems and apparatus include eliminating the need for a parent or caregiver to put on the socks or shoes of the young child, while empowering the child to get dressed with confidence knowing that they have placed their right shoe on the right foot because they have the color-coded right sock on their right foot, and their left foot has the left colored sock and left shoe on it.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### DESCRIPTION OF DRAWINGS

The present embodiments are illustrated by way of the figures of the accompanying drawings, which may not necessarily be to scale, in which like references indicate similar elements, and in which:

FIG. 1 is a front perspective view of the color symbol indicating underwear.

FIG. 2 is a back perspective view of the color symbol indicating underwear.

FIG. 3 is a front perspective view of the shape indicating underwear.

FIG. 4 is a back perspective view of the shape indicating underwear.

FIG. 5 is a side perspective view of the shape indicating socks.

FIG. 6 is a side perspective view of the color symbol indicating socks.

FIG. 7 is a side perspective view of the shape indicating right sock.

FIG. 8 is side perspective view of the shape indicating left sock.

FIG. 9 is a bottom view of the color symbol indicating right sock.

FIG. 10 is a bottom view of the shaped indicating left sock.

### DETAILED DESCRIPTION OF ILLUSTRATIVE EMBODIMENTS

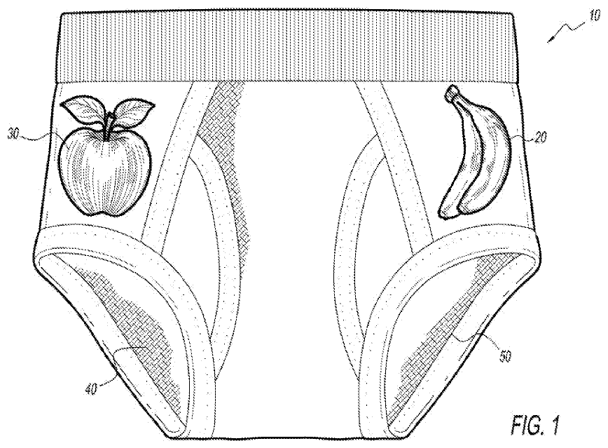

FIG. 1 shows the front view of the food and color indicating underwear 10. The red apple 30 on the right side of the underwear can be associated with the right leg that goes through the right leg opening 40 by the red apple 30. The yellow banana 20 on the left side of the underwear is associated with the left leg that goes into the left leg opening 50 by the yellow banana 20.

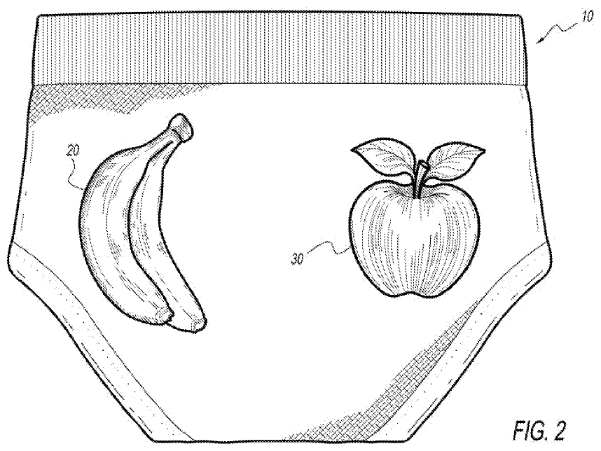

FIG. 2 shows the rear view of the food and color indicating underwear 10. The red apple 30 on the right side of the underwear can be associated with the right leg that goes through the right leg opening by the red apple. The yellow banana 20 on the left side of the underwear is associated with the left leg that goes into the opening by the banana.

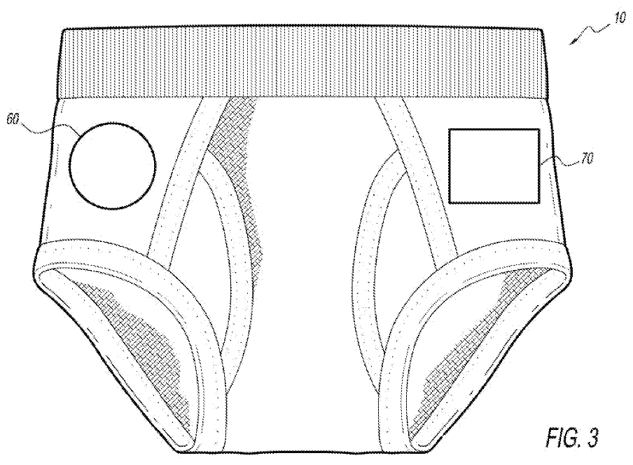

FIG. 3 shows the front view of the shape indicating underwear 10. The green circle 60 is above the opening for the right leg and the blue square 70 is above the opening for the left leg.

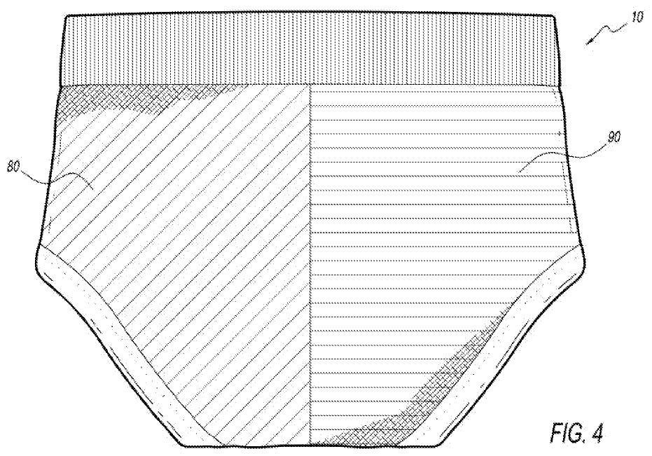

FIG. 4 shows the back side of the color indicating underwear 10. The left side green color 80 and the right side blue color 90 of the right side allow for color association and matching of the left and right side with the hand stickers or the socks.

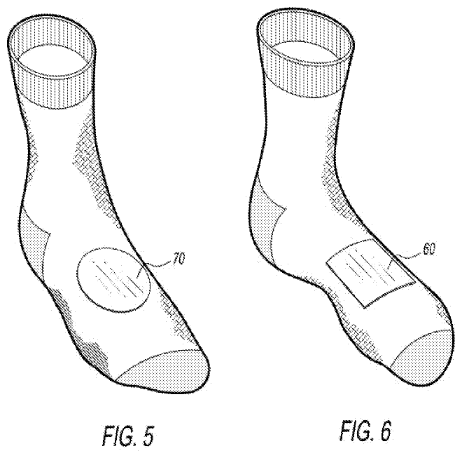

FIG. 5 shows a front perspective view of the green circle 70 on top of the right sock that also corresponds with the circle seen on the right side of the underwear in FIG. 3.

FIG. 6 shows a front perspective view of the left sock, having the blue square 60 to enable the child to remember either the color or the shape, or match the sock with the underwear side shown in FIG. 3 or FIG. 4.

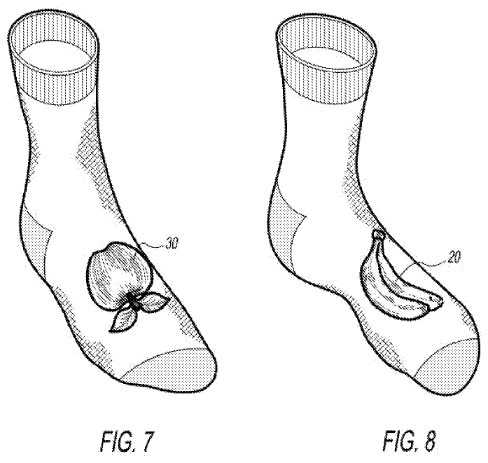

FIG. 7 shows a front perspective view of the right sock, having a red apple 30. The shape also can be matched with the red apple on the right side of the underwear in FIG. 3.

FIG. 8 shows a front perspective view of the left sock, having a yellow banana 20. The shape can also be matched with the shape on the left side of the underwear in FIG. 3.

A number of illustrative embodiments have been described. Nevertheless, it will be understood that various modifications may be made without departing from the spirit and scope of the various embodiments presented herein. For example, the articles of clothing used to teach children basic learning points could also be learning pajamas, and learning shoe laces.

Furthermore, the described features and embodiments of the invention may be combined in any suitable manner in one or more embodiments. One skilled in the relevant art will recognize that the invention can be practiced without one or more of the specific features of a particular embodiment. In other instances, additional features and advantages may be recognized in certain embodiments that may not be present in all embodiments of the invention. Accordingly, these features of the present invention will become more fully apparent from the above descriptions and the appended drawings and claims, or may be learned by the practice of the invention as seen and described hereinafter.

What is claimed is:

1. A learning system for teaching a young child left and right comprising:
An article of clothing having a front, a back, a top, a bottom, a left side, a right side, and one or more images,
a plurality of questions to draw out the connection between the location of the images printed on the article of clothing and the side it corresponds to, and
a follow-up verbal confirmation that the proper connection was made, thereby allowing the child to put the article of clothing on unassisted.

2. The learning system of claim 1 wherein the article of clothing comprises a pair of learning underwear.

3. The learning system of claim 2 wherein the learning system further includes a pair of learning socks.

4. The learning system of claim 1 wherein the article of clothing comprises a set of learning pajamas.

5. The learning system of claim 1 wherein the article of clothing comprises a pair of learning laces.

6. The learning system of claim 2 wherein the printed image is placed on the left side or the right side to associate the printed image with the side it is placed on.

7. The learning article of clothing of claim 2, further comprising one or more colors on the printed image(s).

8. The learning article of clothing of claim 7 wherein the color on the printed image corresponds to the left side or the right side.

9. The article of clothing of claim 8, further comprising a front indicating and back indicating color or word on the waistband.

10. A learning system comprising an article of clothing, and a teaching method, the method comprising:
Providing an article of clothing having identifying shapes and or colors,
Requesting that the child identify the shape printed on the article of clothing,
Requesting that the child identify the color of the shape on the article of clothing,
Requesting the child to identify if the identified shape relates to the left or to the right,
Requesting the child to identify if the color on the clothing relates to left or to right, and
Requesting that the child put the article of clothing on the side that they related it to based on the shape or color they identified with that side.

11. The learning system of claim 10 further comprising a set of adhesive stickers.

12. The learning system of claim 11, wherein the article of clothing comprises:
an elastic waistband for encircling the waist of a child,
a body area having a front, back, left, right, top and bottom side,
an opening for a leg at the bottom of the left side for a left leg,
an opening for a leg at the bottom of the right side for a right leg,
and having reference indicators above the left and right openings.

13. A learning system comprising an article of clothing, a set of adhesive stickers, and a teaching method, the method comprising:
a. Providing an article of clothing having identifying images and colors,
b. Placing an adhesive sticker on a child's left hand that matches the image on the left side of the article of clothing,
c. Placing an adhesive sticker on the child's right hand that matches the image on the right side of the article of clothing,
d. Requesting the child to identify the image on the sticker on their left hand,
e. Requesting the child to match the image on the sticker on their left hand with the image on the article of clothing,
f. Requesting the child to identify the image on the sticker on their right hand,
g. Requesting the child to match the image on their right hand with the image on the right side of the article of clothing,
h. Requesting the child to put the side of the article of clothing that matches the image on their left side on the left leg and foot, and
i. Requesting the child to put the side of the article of clothing that matches the image on their right side on the right leg and foot.

14. The learning system of claim 13, wherein the image on the article of clothing is a food item.

15. The learning system of claim 13, wherein the image on the article of clothing is a vehicle.

16. The learning system of claim 13, wherein the image on the article of clothing is an animal.

17. The learning system of claim 13, wherein the image on the article of clothing is a letter.

18. The learning system of claim 13, wherein the image on the article of clothing is a number.

19. The learning system of claim 13, wherein the image on the article of clothing is a language.
